(19) United States
(12) Patent Application Publication
(10) Pub. No.: US 2003/0051646 A1
(43) Pub. Date: Mar. 20, 2003

(54) Beach safe

(76) Inventor: Vincent Joseph Cinquegrano, Casselberry, FL (US)

Correspondence Address: VINCENT JOSEPH CINQUEGRANO, 133 MARK DAVID BLVD., CASSELBERRY, FL, 32707, US

(21) Appl. No.: 09/773,149

(22) Filed: Aug. 13, 2001

(51) Int. Cl. E05G 1/00

(52) U.S. Cl. 109/50

(57) ABSTRACT

A basic cooler any size, used as a safe for personal belongings, not food or drinks. The floor of the safe has two holes through it, one at each end. The holes are for two rods to go through so the safe is secured to the ground. The rods are made of steel ½″ thick. The rods are 21½″ long. 14½″ of it is in a corkscrew shape 2″ wide. From the corkscrew, there is a straight piece 5″ long, which goes to a handle. The handle is 2″ long. The carrying handles outside of the safe are removable, so there is nothing to use to pull the safe up from the ground. The cover to the safe has a combination lock on it.

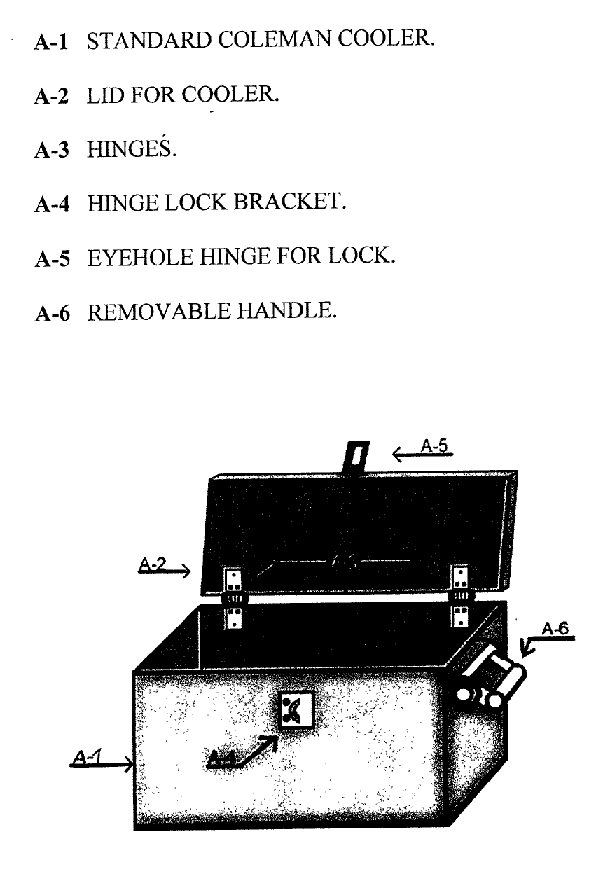

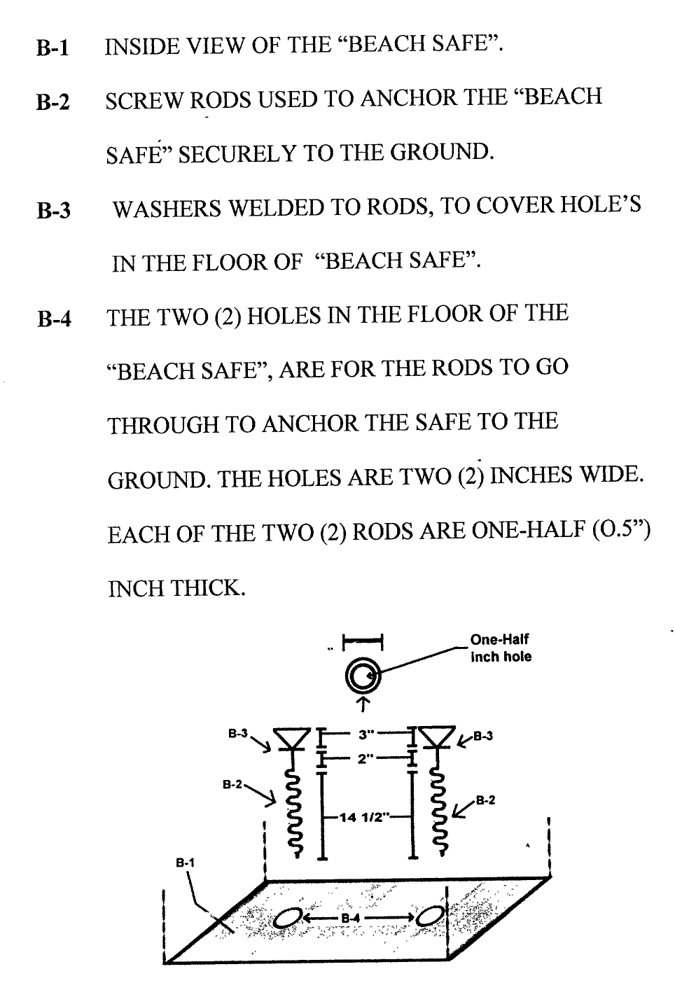

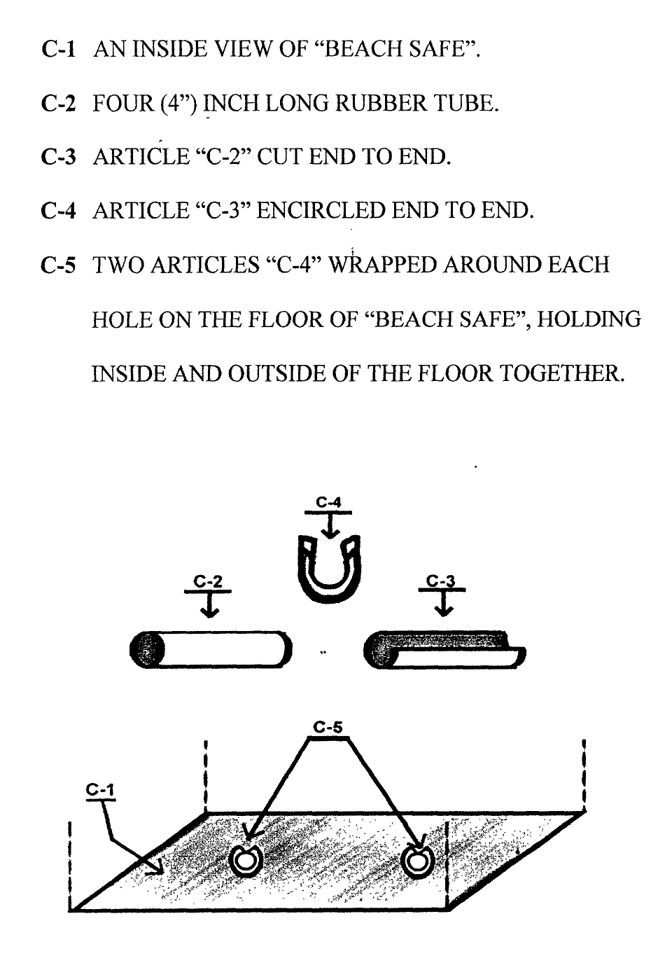

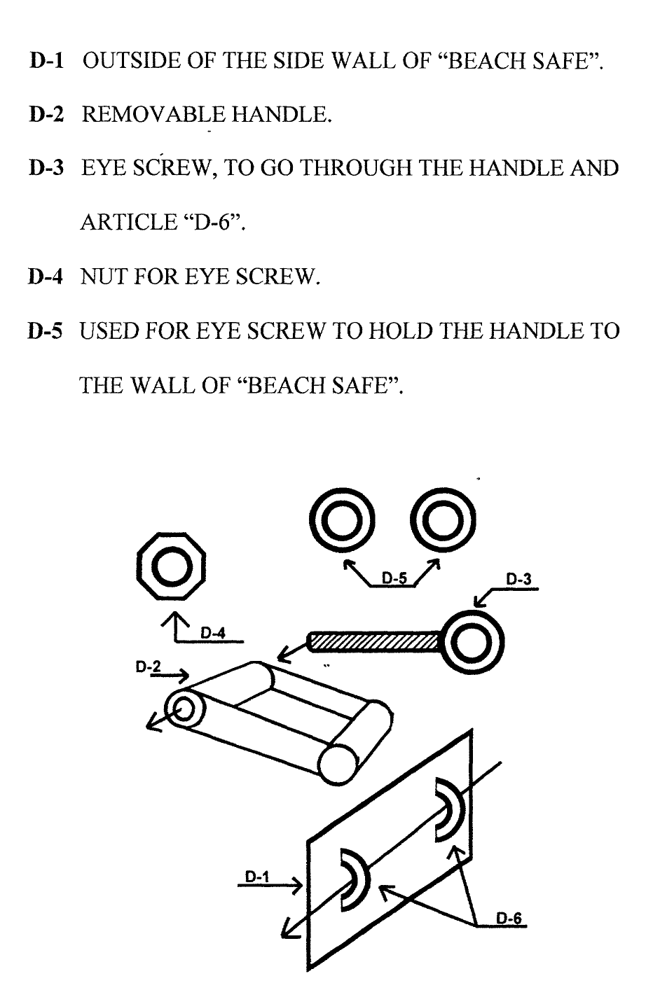

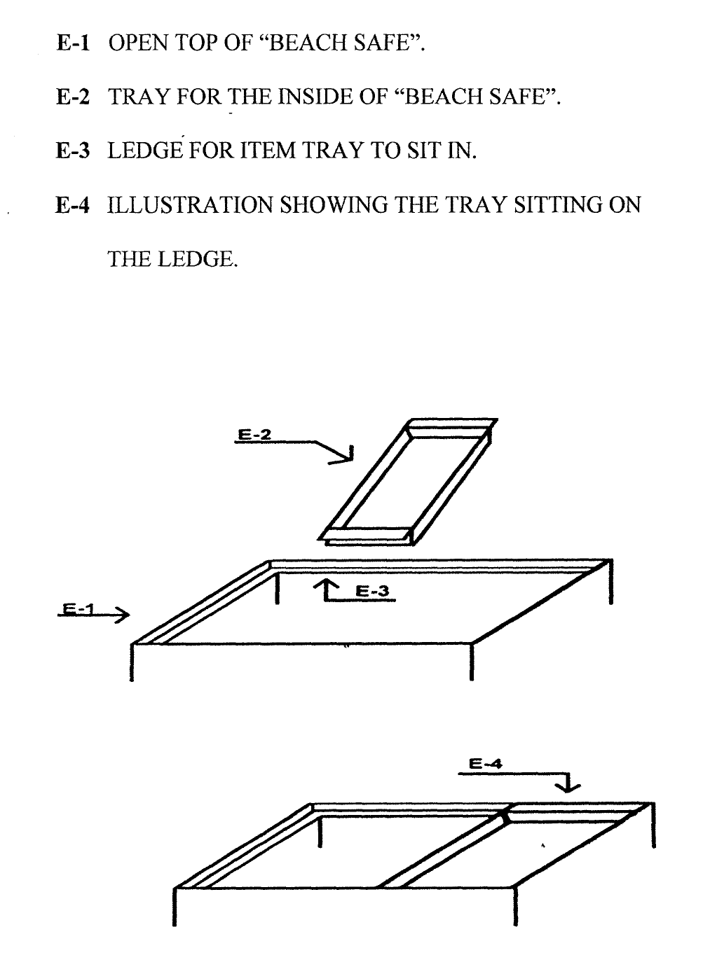

### BACKROUND OF THE INVENTION

The present invention relates to securing personal belongings and more particularly as a portable safe to put these items in. Too many times I've heard people complaining that things of value have been stolen from their blanket at the beach. It is so easy for someone to just walk up to a blanket, pick something up and walk away with it, while you are in the water. With The Beach Safe, it would take too long and too much work to steal your personal belongings. You, or someone else would notice the act of theft taking place.

### SUMMARY OF THE INVENTION

The invention relates to a theft deterrent system. This system is a lightweight, hard box like enclosure with two holes on the floor. Through each hole inserts heavy-duty corkscrews that are screwed through the sand, stopping it from being just pulled out. The box also has a lock bracket with an eyehole and removable handles. There is a lid connected to the box by hinges with another lock bracket that connects to a box lock bracket with a combination lock to securely close box.

### BRIEF DESCRIPTION OF THE DRAWINGS

FIG. A is a perspective view of outside of safe.

FIG. B is an inside bottom view of the holes and corkscrew rods.

FIG. C is a bottom view of holes and rubber tubing placed around holes to hold the inside and outside of safe.

FIG. D is an outside view of one of the side walls, where the removable handles are.

FIG. E is a small tray that sits on a large tray which is used for small articles.

### DETAILED DESCRIPTION OF THE INVENTION

Referring to Fig A. will be A-1 through A-6. A-1 is a box safe for holding your personal belongings. A-2 is a lid for said box. A-3 Are two hinges for lid to swing open and close. A-4 is a hinge lock bracket with an eyehole to go through A-5 lock hinge. A-5 is a bracket with a hinge to swing on and off. A-4 is a bracket that has an eyehole for A-4 to go through so lock can be put in place. A-6 is to show handle before removed from (box) or safe.

Referring to Fig. B will be B-1 through B-4. B-1m is an inside view of floor to safe. B-4 are the two holes that B-2 rods go through to secure safe to ground. B-2 are the rods that go through the holes to secure safe to ground. B-3 are washers welded to rods B-2 so that when rods are in place they will cover the holes. B-4 on floor. B-1 of safe.

Referring to Fig. C will be C-1 through C-5. C-2 are rubber hoses (×2) before they are cut. They are 4″ long and 1!/2″ wide. They are cut end to end as seen in C-3. C-3 are the hoses cut end to end to be encircled as seen in C-4 to make ready to be placed on floor of safe, C-1 as seen with C-5. C-5 shows rubber hose C-3 and C-4 in place on floor, C-1 of safe. Placed on inside and outside of safe floor C-1 together.

Referring to Fig. D will be D-1 through D-6. D-2 is the removable handle. It fits between D-6. D-6 are the two eyeholes. When D-2 is in place with D-6 one of D-5 washers will be placed on D-3 eyehole screw pin. Pins are 7″ long. Then D-3 will be placed through D-6 right side and then through D-2 and then D-6 left side. Once in place the second D-5 will be placed on the D-3. Then D4, the nut will hold D-3 and D-2 in place. Fig. D will be removed from safe A-1 when safe A-1 is in place and secured.

Referring to Fig E. will be E-1 through E4. E-1 is a perspective view of the inside of the safe, ledge on top of walls. E-3 shows ledge for E-2 tray to sit on. AE-2 is for holding small belongings. E-4 shows E-2 tray already in place.

1. What I claim as my invention is called “THE BEACH SAFE”. The purpose of this product, is to make it difficult for anyone to approach an individuals unsupervised possessions, and having them stolen. With your valuables stored away inside “THE BEACH SAFE”, theft would take too much time, and would not go unnoticed by owner or others. “THE BEACH SAFE” size can be chosen by individual needs.
